(19) United States
(12) Patent Application Publication
(10) Pub. No.: US 2006/0228165 A1
(43) Pub. Date: Oct. 12, 2006

(54) Reusable, breakaway connector section for highway sign posts

(76) Inventor: Joseph A. Yonan III, Turlock, CA (US)

Correspondence Address: R. MICHAEL WEST LAW OFFICES OF;R. MICHAEL WEST, A PROFESSIONAL CORPORATION, 455 CAPITOL MALL; SUITE 405, SACRAMENTO, CA, 95814-4603, US

(21) Appl. No.: 11/102,491

(22) Filed: Apr. 8, 2005

(51) Int. Cl. F16B 1/00

(52) U.S. Cl. 403/2

(57) ABSTRACT

A reusable breakaway connector section for use with highway sign posts. An insert has a female receiver at its upper end. A plug having a lower male projection, is mated within the female receiver. A spring extends upwardly, from the upper end of the plug. A cable extends from the upper end of the spring, through the spring, the plug, and the insert, and is connected to the lower end of the insert. The cable compresses the spring, resiliently biasing the male projection into the female receiver while maintaining the insert, the plug, and the spring in axial alignment. The insert is installed in a ground sleeve and a sign post is installed over the spring and the plug. Lateral forces imposed on the sign post cause the male projection to be temporarily dislodged from the female receiver. Righting the post allows the projection and the receiver to mate again.

### BACKGROUND OF THE INVENTION

1. Field of the Invention

The invention relates generally to support posts for highway related road signs, which include a breakaway portion or section to minimize damage to a colliding vehicle and the sign itself. More particularly, the invention pertains to a spring-loaded, reusable, connector section which allows a post-mounted sign to be righted after being knocked over, and immediately put to use again without other repair or replacement of parts.

2. Description of the Prior Art

Post-mounted highway signs are particularly vulnerable to damage or destruction from motor vehicles. Located adjacent highways, often at intersections, curves, or other hazardous highway conditions, signs are often hit by motor vehicles leaving the road. If the mounting or support post for the sign is wooden, the vehicle impact typically snaps off the post at ground level. Metal posts may either bend or snap upon impact, but the end result is generally the same. Once the damage has been discovered, major repairs and/or replacement of the post and sign must be undertaken. In the meantime, the warning or instructions given by the sign are not seen, and subsequent accidents may occur as a direct result of the visual absence of the sign.

In an effort to overcome the breakage problem and the attendant expenses, post supports have been designed which have a sacrificial element or structure which may be replaced to restore the integrity of the post after vehicle impact. For example, in U.S. Pat. No. 4,858,876 issued to Moreno, a breakaway connection includes a shear pin provided with flats to prevent rotation of the post with respect to the ground support. The construction in the Moreno device also includes a retaining cable provided with sufficient slack so the post can be sheared away, yet the cable prevents the post and the attached sign from becoming dislodged, thrown, or stolen.

In another example, a restorable breakaway post is shown in U.S. Pat. No. 5,484,217, granted to Carroll et al. This construction shows a breakable splice plate and a flexible member, connecting the breakaway post to the base post. Upon impact, the splice plate shears allowing the breakaway post to move away from the base post, while the flexible member ensures that the two posts do not become too far removed from each other. The splice plate is then replaced to restore use of the post.

Other highway sign post constructions advocating the use of a frangible or bendable sacrificial section to effect a breakaway function include: U.S. Pat. No. 5,794,910 issued to Granger; U.S. Pat. No. 5,214,886 granted to Hugron; U.S. Pat. No. 6,560,906 granted to Hillstrom; U.S. Pat. No. 6,113,055 issued to Salman; U.S. Patent Application No. US 2003/0183740 A1 filed by Knapp et al.; and U.S. Pat. No. 6,626,410 issued to Marcotte et al.

However, there is a need for a connector section for highway sign posts which features a breakaway function yet is fully and readily restorable without the need for replacement parts or labor-intensive efforts.

There is also a need for a connector section for highway sign posts which is sufficiently resilient to give way upon vehicle impact yet is resistant to breakaway under strong wind conditions.

There is also a need for a connector section for highway sign posts which is both economical to manufacture and readily adaptable for use with existing ground sleeves supporting current sign posts.

These and other objects of the present invention will be described in the drawings and in the detailed description of the preferred embodiment set forth below.

### SUMMARY OF THE INVENTION

The breakaway connector section of the present invention includes an insert having a female receiver at its upper end. A plug is provided, having a male projection at its lower end. The female receiver and the male projection have corresponding mating configurations, so that one may nest snugly within the other. The plug also includes an aperture extending from its upper end through the lower end of the male projection.

The connector also includes an elongated spring, having its bottom end in contingent relation with the upper end of the plug. A flexible cable is provided, having its upper end attached to the top end of the spring. The cable has an intermediate portion which passes through the spring along its longitudinal axis, through the aperture in the plug, and substantially through the full extent of the insert. The lower end of the cable includes a threaded rod portion which passes through a retainer plate in the lower end of the insert and is adjustably secured thereto by means of a threaded nut.

The flexible cable has an overall length such that the spring is moderately compressed between the upper end of the cable and the upper end of the plug. The spring thereby resiliently biases the male projection of the plug into the female receiver of the insert, maintaining the insert, the plug, and the spring generally in axial alignment. The tension of the spring is adjustable by loosening or tightening the nut at the lower end of the insert.

During assembly, the insert is slid into a ground sleeve, extending approximately two feet or so into the ground. Lateral screws secure the insert within the sleeve. A sign post is slid over the cable and spring assembly, until it reaches the upper end of the plug. Again, lateral screws secure the sign post to the plug. The resilient bias provided by the spring is sufficient to maintain the insert, the ground sleeve, and the sign post in axial alignment, even during stiff winds.

However, if the sign post is impacted by a motor vehicle, the force is sufficient to overcome the resilient bias, removing the male projection from the female receiver, and allowing the sign post and sign to tilt over to a horizontal position. The flexible cable acts to maintain the sign post, the ground sleeve, and the breakaway connector section together.

Then, by merely lifting and righting the sign post to an upright position, the tension of the spring in combination with the flexible cable, guide the male projection back into the female receiver. Normal use of the sign post is thereby restored quickly and easily, without resort to replacing broken or damaged parts.

### BRIEF DESCRIPTION OF THE DRAWINGS

FIG. 1 is a perspective view of a stop sign incorporating the breakaway connector section of the present invention, the broken-line representation showing the knock over and righting process for the stop sign;

FIG. 2 is a fragmentary, perspective view of the connector section and the ground sleeve;

FIG. 3 is a fragmentary, perspective view of the connector section broken-away from its normal upright position;

FIG. 4 is an exploded perspective view showing the ground sleeve, the connector section, and the sign post;

FIG. 5 is an exploded perspective view of the connector section, showing its component parts in a disassembled state;

FIG. 6 is a fragmentary, cross-sectional view of the ground sleeve, the connector section, and the sign post in their normal upright position;

FIG. 7 is a view as in FIG. 6, but showing the connector section in a broken-away condition;

FIG. 8 is a perspective view of a first alternative embodiment of the connector section, adapted to accommodate a right-circular cylindrical sign post; and,

FIG. 9 is a perspective view of a second alternative embodiment of the connector section, utilizing frusto-conical mating elements.

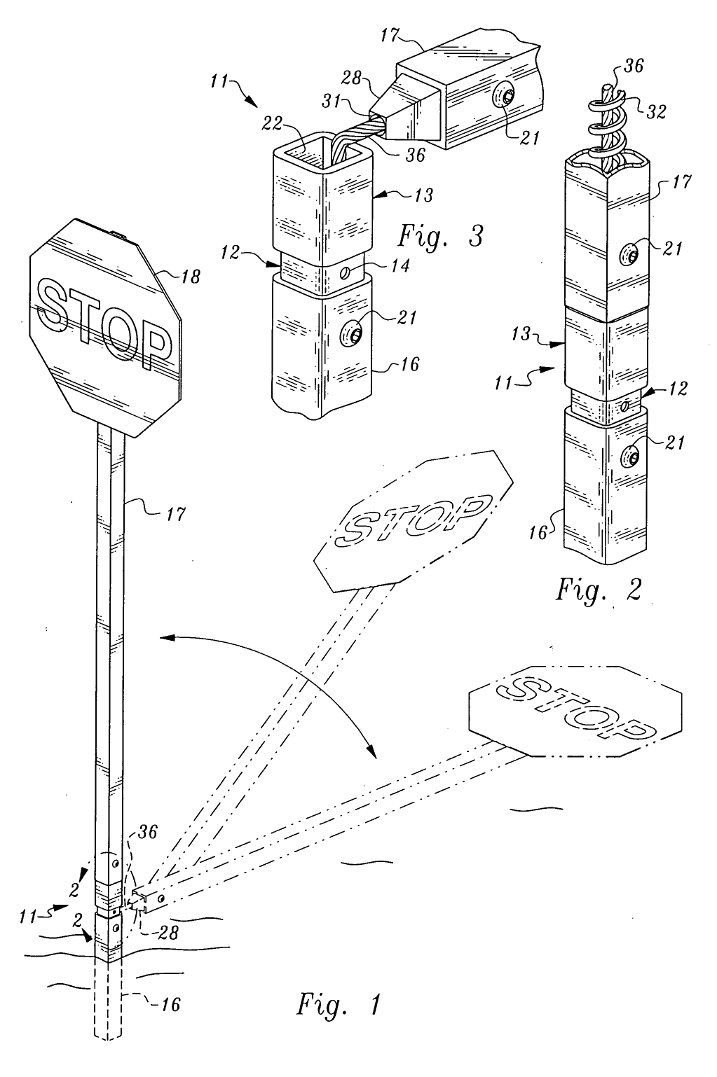

### DETAILED DESCRIPTION OF THE PREFERRED EMBODIMENT

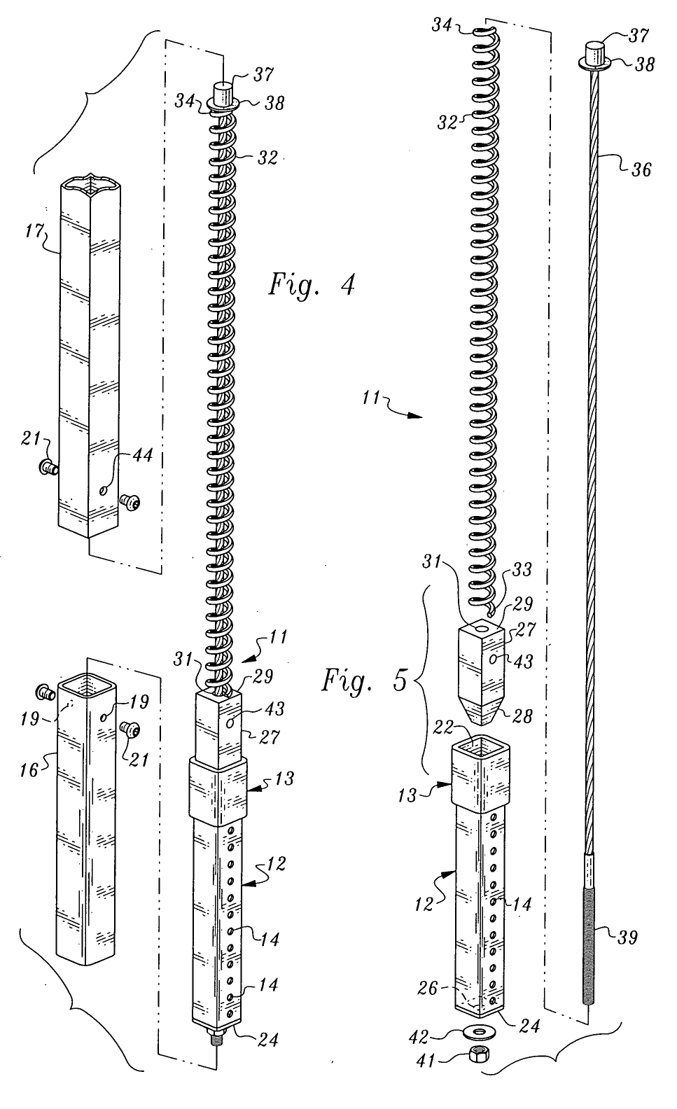

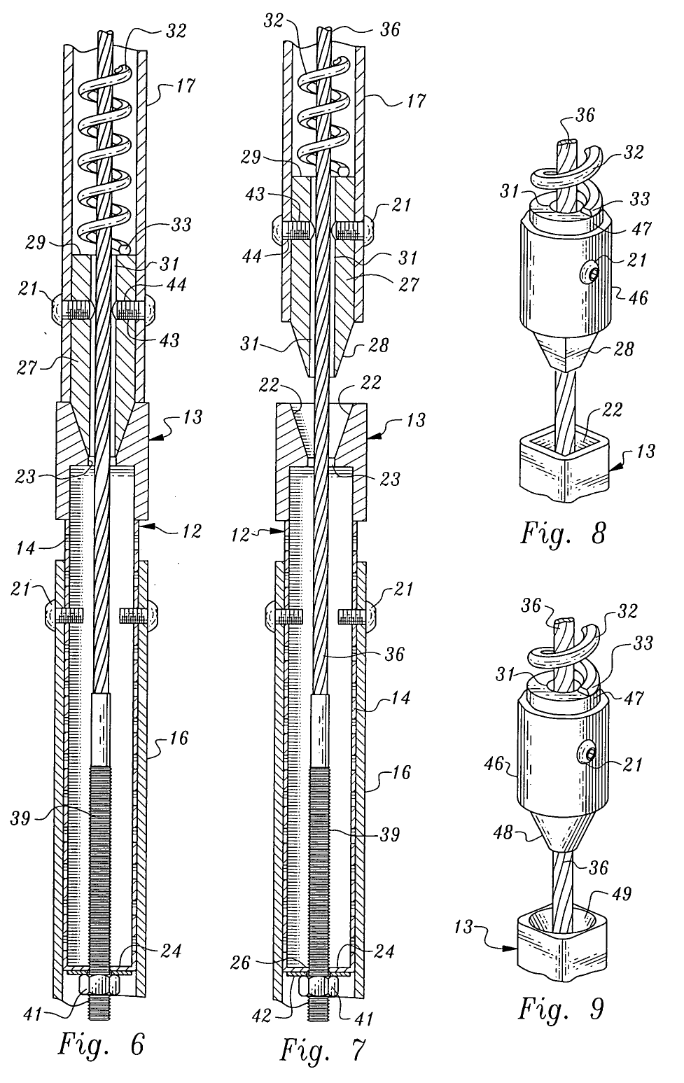

Turning now to the drawings, and in particular to FIGS. 4 and 5, the breakaway connector section 11 of the present invention includes an insert 12 having a female receiver 13 located at its upper end. Insert 12 is preferably manufactured from an elongated piece of square stock tubing, provided with a plurality of mounting holes 14 extending along two opposing sidewalls. Insert 12 is sized and configured so it may easily be slid into a ground sleeve 16.

In the event that the connector section 11 is being retrofitted to an existing sign post installation, including a sign post 17 and a highway sign 18, ground sleeve 16 would likely be pre-existing. Ground sleeve 16 typically extends approximately two feet, or so, into the ground, and may be set in concrete for additional strength and stability. Of course in a new installation, the ground sleeve and the insert may be any desired size and configuration.

Ground sleeve 16 includes opposing bores 19 at its upper end. After insert 12 is located at the desired elevation, generally an inch or so above ground level, self-tapping screws 21 are passed through bores 19 and threaded into corresponding mounting holes 14. Screws 21 are provided with non-standard tool engagement holes to deter theft and tampering.

The upper end of female receiver 13 is provided with a recess 22, of pyramidal configuration, having four downwardly converging walls. A cable passageway 23 is provided at the lowermost point of the recess 22. A retainer plate 24 is transversely positioned over the lower end of insert 12. As shown in FIG. 5, a rod hole 26 is centrally located within retainer plate 24.

Connector section 11 also includes a generally solid plug 27, having a male projection 28 at its lower end and a flat 29 at its upper end. Male projection 28 is also pyramidal in configuration, having four downwardly converging sides. Furthermore, the recess 22 of female receiver 13 and the male projection 28 are of corresponding mating configurations so that projection 28 nests snugly within recess 22. Plug 27 also includes an elongated aperture 31 extending from flat 29 through the lower end of male projection 28.

Connector section 11 further includes an elongated helical spring 32, having a bottom end 33 in contingent relation with flat 29 on the upper end of plug 27, and a top end 34. A flexible cable 36 is also provided, having a cylindrical stud 37 and a washer 38 at its upper end. A threaded rod 39 is provided at the lower end of cable 36. During assembly, threaded rod is passed first through the top end 34 and then through the full extent of helical spring 34. Next, rod 39 is passed through aperture 31 in plug 27, through cable passageway 23 in recess 22, through insert 12, and finally through hole 26 in retainer plate 24. So installed, the portion of cable 36 intermediate its upper end and its lower end, passes through the longitudinal axes of the spring 32, the plug 27, and the insert 12.

A retainer nut 41 with a washer 42 are installed over threaded rod 39. As nut 41 is further screwed on rod 39, the effective length of cable 36 is shortened, compressing the assembly comprising spring 32, plug 27 and insert 12 while generally maintaining the axes of these components in alignment. Spring 32 thereby resiliently biases male projection 28 of the plug 27 into recess 22 of the female receiver 13. Because tension of the spring 32 is adjustable by loosening or tightening the nut 41, the amount of force required to dislodge projection 28 from recess 22 is primarily a function of the inherent resilient force of the spring combined with the adjustment of nut 41.

With the insert 12 previously installed in ground sleeve 16, all that remains to complete the assembly is to install the sign post 17 over plug 27 and the assembled spring 32 and cable 36. For that purpose, a pair of opposing mounting holes 43 are provided in plug 27. And, corresponding bores 44 are provided in the lower portion of sign post 17. After the lower portion of sign post 17 is slipped over plug 27, self-tapping screws 21 are installed through bores 44 and into mounting holes 43.

The resilient bias provided by the spring 32, when moderately compressed, should be sufficient to maintain the sign post and the connector section 11 in axial alignment, even during stiff winds. It should be evident that if the resilient capabilities of the spring are too small, or if the spring is not sufficiently compressed, the sign post and sign will topple over during windy conditions. On the other hand, the resiliency and compression of the spring 32 should not be so great that the connector section 11 requires great force to breakaway. The constituent material of the spring, the length of the spring, the number of turns per inch, and the diameter of the spring all come into play in determining its resilient capabilities for use in the present application.

If the sign post 17 is impacted by a motor vehicle, the lateral forces will be sufficient to overcome the resilient bias provided by the spring 32, dislodging the male projection 28 from the recess 22 withing the female receiver 13, allowing the sign post 17 and sign 18 to tilt over to a horizontal position. (See, FIG. 1). The flexible cable 36 acts to keep sign post 17, the ground sleeve 16, and the breakaway connector section 11 physically connected. Thus, even though the sign post and the sign are knocked over, they will remain physically attached to the other components, preventing loss or theft.

Once the offending motor vehicle has been removed from the vicinity of the sign post 17, the sign post may easily be lifted to again assume an upright, vertical position. Owing to the distended condition of the connector section 11, the tension of the spring 32 is increased over that present when the connector section is nested an in axial alignment. Thus, this enhanced bias provided by the spring in combination with general guidance provided by the flexible cable 36, direct the male projection 28 back into the female receiver 13. Normal use of the sign post and sign 18 is thereby restored quickly and easily, without having to replace broken or damaged parts. This restoration of normal use can also be accomplished by a person without any special training or tools, increasing the chances that the safety warning provided by the sign will be provided quickly.

Several minor modifications to the basic construction provide additional flexibility for different installations. For example, in the construction described above, the sign post 17 and the plug 27 are square in cross-section. In FIG. 8, a construction is disclosed in which the sign post 46 and the plug 47 are circular in cross-section. This construction may be desirable or required where the pre-existing sign post is a right-circular cylindrical tube.

In FIG. 9, another modified construction is shown where male projection 48 and mating recess 49 are frusto-conical in configuration. This construction provides generally equal breakaway capabilities, where the sign post may be impacted from a random direction. Otherwise, the features and capabilities of this modified construction are identical to the construction of the invention as described above.

It will be appreciated, then, that I have disclosed a reusable, breakaway connector section for highway sign posts which features a breakaway function and is also fully and readily restorable without the need for replacement parts or labor-intensive efforts.

What is claimed is:

1. A breakaway connector section comprising:
a. an insert having an upper end and a lower end, said upper end including a female receiver;
b. a plug having an upper end and a lower male projection, said receiver and said projection having corresponding, mating configurations, said plug having an aperture extending from said upper end to said projection;
c. a spring having a top end and a bottom end, said bottom end being in contact with said upper end of said plug;
d. a cable having an upper end and a lower end, said upper end of said cable being attached to said top end of said spring, an intermediate portion of said cable passing through said spring, said aperture, and said insert, and said lower end of said cable being attached to said lower end of said insert, whereby said cable has an overall length so that said spring resiliently biases said male projection of said plug into said female receiver of said insert, maintaining said insert, said plug, and said spring in axial alignment.

2. A breakaway section as in claim 1 in which said female receiver and said male projection have pyramidal configurations, with downwardly converging walls.

3. A breakaway section as in claim 1 in which said female receiver and said male projection have frusto-conical configurations, with downwardly converging walls.

4. A breakaway section as in claim 1 in which said plug is square in cross-section.

5. A breakaway section as in claim 1 in which said plug is circular in cross-section.

6. A breakaway section as in claim 1 in which said lower end of said cable includes a threaded rod, and in which said lower end of said insert includes a retainer plate with a hole therein for passage of said threaded rod, and further including a nut threadably engaging said rod on a lower side of said retainer plate, so that said cable may be adjusted in length varying the amount of said resilient bias.

7. A breakaway sign post assembly comprising:
a. an insert having an upper end and a lower end, said upper end including a female receiver;
b. a plug having an upper end and a lower male projection, said receiver and said projection having corresponding, mating configurations, said plug having an aperture extending from said upper end to said projection;
c. a spring having a top end and a bottom end, said bottom end being in contact with said upper end of said plug;
d. a cable having an upper end and a lower end, said upper end of said cable being attached to said top end of said spring, an intermediate portion of said cable passing through said spring, said aperture, and said insert, and said lower end of said cable being attached to said lower end of said insert, said cable compressing said spring thereby resiliently biasing said male projection of said plug into said female receiver of said insert;
e. a ground sleeve installed within the ground, said ground sleeve being sized and configured to receive at least said lower end of said insert; and,
f. a sign post having a lower portion installed over said spring and at least said upper end of said plug, and an upper portion provided with a sign.

8. A breakaway sign post as in claim 7 in which said female receiver and said male projection have pyramidal configurations, with downwardly converging walls.

9. A breakaway sign post as in claim 7 in which said female receiver and said male projection have frusto-conical configurations, with downwardly converging walls.

10. A breakaway sign post as in claim 7 in which said plug is square in cross-section.

11. A breakaway sign post as in claim 7 in which said plug is circular in cross-section.

12. A breakaway section as in claim 7 in which said lower end of said cable includes a threaded rod, and in which said lower end of said insert includes a retainer plate with a hole therein for passage of said threaded rod, and further including a nut threadably engaging said rod on a lower side of said retainer plate, so that said cable may be adjusted in length varying the amount of said resilient bias.

13. A breakaway connector section comprising:
a. an insert having an upper end and a lower end, said upper end including a female receiver;
b. a plug having an upper end and a lower male projection, said receiver and said projection having corresponding, mating configurations; and,
c. means for resiliently biasing said male projection into mating engagement with said female receiver and for maintaining a flexible mechanical interconnection between said insert and said plug, whereby said insert and said plug are maintained in axial alignment until sufficient lateral and axial forces imposed on said plug cause said male projection to be temporarily disengaged from said female receiver.

14. A breakaway connector section as in claim 13 in which said plug has an aperture extending from said upper end to said projection and in which said resilient biasing means and said flexible mechanical interconnection means comprise: a spring having a top end and a bottom end, said bottom end being in contact with said upper end of said plug, and a cable having an upper end and a lower end, said upper end of said cable being attached to said top end of said spring, an intermediate portion of said cable passing through said spring, said aperture, and said insert, and said lower end of said cable being attached to said lower end of said insert, whereby said cable has an overall length so that said spring is compressed.

15. A breakaway section as in claim 13 in which said female receiver and said male projection have pyramidal configurations, with downwardly converging walls.

16. A breakaway section as in claim 13 in which said female receiver and said male projection have frusto-conical configurations, with downwardly converging walls.

17. A breakaway section as in claim 13 in which said plug is square in cross-section.

18. A breakaway section as in claim 13 in which said plug is circular in cross-section.

19. A breakaway section as in claim 13 in which said lower end of said cable includes a threaded rod, and in which said lower end of said insert includes a retainer plate with a hole therein for passage of said threaded rod, and further including a nut threadably engaging said rod on a lower side of said retainer plate, so that said cable may be adjusted in length varying the amount of said resilient bias.
